(19) United States
(12) Patent Application Publication
(10) Pub. No.: US 2014/0269613 A1
(43) Pub. Date: Sep. 18, 2014

(54) Integrity protection towards one CN after handovers involving multiple services to be handled by different CNs

(71) Applicant: NOKIA SIEMENS NETWORKS OY, Espoo (FI)

(72) Inventors: Bindhya V. Tiwari, Vantaa (FI); Devaki Chandramouli, Plano, TX (US); Woonhee Hwang, Espoo (FI); Guenther Horn, Munchen (DE); Curt Wong, Sammamish, WA (US); Paula H. Siren, Vantaa (FI)

(73) Assignee: Nokia Siemens Networks Oy, Espoo (FI)

(21) Appl. No.: 13/846,054

(22) Filed: Mar. 18, 2013

(51) Int. Cl. H04W 36/00

(52) U.S. Cl. CPC H04W 36/0022
USPC 370/331

(57) ABSTRACT

A method includes receiving at a UE information indicating different CN domains will be used for first and second data services after handover from a first RAT to a second RAT. Integrity protection is activated for the first and second CN domains but an element in the UE does not have an indication integrity protection is activated for the second CN domain. The UE provides a notification for the element that integrity protection has been activated for the second CN domain. Another method includes receiving at a network node a message indicating a UE has performed a handover involving first and second data services from a first to a second RAT, where the first and second data services will be handled by different core network domains. A security mode control procedure is performed to activate integrity protection towards the second core network domain. Apparatus and program products are disclosed.

### TECHNICAL FIELD

This invention relates generally to wireless networks and, more specifically, relates to handover from one radio access technology to another radio access technology.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, prior to the claims.

Many mobile communications networks support circuit switched (CS) and packet switched (PS) data. Circuit switched data is typically voice data and allows a UE (e.g., a mobile telephone) to connect to another UE over a public switched telephone network (PSTN). Packet switched data, by contrast, may contain voice (e.g., via VoIP) and many other types of data such as video. Data is packaged used packets and is transmitted using IP techniques.

3GPP TS 23.216 introduced Single Radio Voice Call Continuity (SRVCC), a feature which enables an IMS voice user (using packet switched data) in LTE to be transferred to 3G/2G via an inter-RAT handover, when there is no LTE coverage from IMS/IP to a standard CS domain in 3G/2G. Thus, a user seamlessly transfers from LTE to a 3G/2G network, where VoIP would not be supported, without the call being dropped. SRVCC can be performed from UTRAN to UTRAN/GERAN in addition to being performed from E-UTRAN to UTRAN/GERAN. When a user having a PS application running in E-UTRAN along with IMS Voice is transferred to UTRAN, IMS voice is switched to a legacy CS domain voice call by using the SRVCC procedure and PS service is transferred as such.

Although there are benefits to these types of inter-RAT handovers, there are also elements that could be improved.

### SUMMARY

This section is intended to provide exemplary overviews and is not meant to be limiting.

An exemplary method is disclosed that includes receiving at a user equipment information indicating different core network domains will be used for a first data service and a second data service after handover from a first radio access technology to a second radio access technology. The first data service will be handled by a first one of the different core network domains after handover and the second data service will be handled by a second one of the different core network domains after handover. The integrity protection is activated for both the first and second core network domains but an element in the user equipment does not have an indication integrity protection is activated for the second core network domain. The method includes providing by the user equipment a notification for the element in the user equipment that integrity protection has been activated for the second core network domain.

An exemplary embodiment is an apparatus including one or more processors and one or more memories including computer program code. The one or more memories and the computer program code configured to, with the one or more processors, cause the apparatus to perform at least the following: receiving at a user equipment information indicating different core network domains will be used for a first data service and a second data service after handover from a first radio access technology to a second radio access technology, wherein the first data service will be handled by a first one of the different core network domains after handover and the second data service will be handled by a second one of the different core network domains after handover, wherein integrity protection is activated for both the first and second core network domains but an element in the user equipment does not have an indication integrity protection is activated for the second core network domain; and providing by the user equipment a notification for the element in the user equipment that integrity protection has been activated for the second core network domain.

Another exemplary embodiment is an apparatus. The apparatus comprises: means for receiving at a user equipment information indicating different core network domains will be used for a first data service and a second data service after handover from a first radio access technology to a second radio access technology, wherein the first data service will be handled by a first one of the different core network domains after handover and the second data service will be handled by a second one of the different core network domains after handover, wherein integrity protection is activated for both the first and second core network domains but an element in the user equipment does not have an indication integrity protection is activated for the second core network domain; and means for providing by the user equipment a notification for the element in the user equipment that integrity protection has been activated for the second core network domain.

A further exemplary embodiment is a computer program product comprising a computer-readable storage medium bearing computer program code embodied therein for use with a computer. The computer program code comprises: code for receiving at a user equipment information indicating different core network domains will be used for a first data service and a second data service after handover from a first radio access technology to a second radio access technology, wherein the first data service will be handled by a first one of the different core network domains after handover and the second data service will be handled by a second one of the different core network domains after handover, wherein integrity protection is activated for both the first and second core network domains but an element in the user equipment does not have an indication integrity protection is activated for the second core network domain; and code for providing by the user equipment a notification for the element in the user equipment that integrity protection has been activated for the second core network domain.

An additional exemplary embodiment is a method. The method includes receiving at a network node a message indicating a user equipment has performed a handover involving a first data service and a second data service from a first radio access technology to a second radio access technology. The first data service will be handled by a first one of the different core network domains after handover and the second data service will be handled by a second one of the different core network domains after handover. The method includes performing, in response to the message, by the network node a security mode control procedure to activate integrity protection towards the second core network domain.

An apparatus in another exemplary embodiment includes: means for receiving at a network node a message indicating a user equipment has performed a handover involving a first data service and a second data service from a first radio access technology to a second radio access technology, wherein the first data service will be handled by a first one of the different core network domains after handover and the second data service will be handled by a second one of the different core network domains after handover; and means for performing, in response to the message, by the network node a security mode control procedure to activate integrity protection towards the second core network domain.

An exemplary embodiment is an apparatus including one or more processors and one or more memories including computer program code. The one or more memories and the computer program code configured to with the one or more processors, cause the apparatus to perform at least the following: receiving at a network node a message indicating a user equipment has performed a handover involving a first data service and a second data service from a first radio access technology to a second radio access technology, wherein the first data service will be handled by a first one of the different core network domains after handover and the second data service will be handled by a second one of the different core network domains after handover; and performing, in response to the message, by the network node a security mode control procedure to activate integrity protection towards the second core network domain.

A further exemplary embodiment is a computer program product comprising a computer-readable storage medium bearing computer program code embodied therein for use with a computer. The computer program code comprises: code for receiving at a network node a message indicating a user equipment has performed a handover involving a first data service and a second data service from a first radio access technology to a second radio access technology, wherein the first data service will be handled by a first one of the different core network domains after handover and the second data service will be handled by a second one of the different core network domains after handover; and code for performing, in response to the message, by the network node a security mode control procedure to activate integrity protection towards the second core network domain.

### BRIEF DESCRIPTION OF THE DRAWINGS

In the attached Drawing Figures:

FIG. 1 illustrates a block diagram of an exemplary wireless network in which the exemplary embodiments may be practiced;

FIG. 2 is a block diagram of a portion of the wireless network shown in FIG. 1;

FIG. 3 is a logic flow diagram for integrity protection towards PS CN after handovers involving voice and PS services for a first example, and illustrates the operation of an exemplary method, a result of execution of computer program instructions embodied on a computer readable memory, and/or functions performed by logic implemented in hardware, in accordance with an exemplary embodiment;

FIG. 4 is an illustration of a protocol stack for a PS domain;

FIG. 5 is an illustration of a protocol stack for a CS domain;

FIG. 6 is a logic flow diagram for integrity protection towards PS CN after handovers involving voice and PS services for a second example, and illustrates the operation of an exemplary method, a result of execution of computer program instructions embodied on a computer readable memory, and/or functions performed by logic implemented in hardware, in accordance with an exemplary embodiment.

### DETAILED DESCRIPTION OF THE DRAWINGS

As described above, there are elements that could be improved for inter-RAT handovers. These problems will be described in more detail, once an overview of a system into which the exemplary embodiments may be used is described.

Turning now to FIG. 1, this figure illustrates a block diagram of an exemplary wireless network into which the instant invention may be used. FIG. 1 illustrates three systems, each having different radio access technologies: E-UTRAN 101, UTRAN 102, and GERAN 103. Each of these systems is roughly divided into a radio access network (RAN) 115 and a core network (CN) 130. For ease of explanation, the many connections between various entities in FIG. 1 are not discussed. Furthermore, the systems 101, 102, and 103 are merely representations for ease of exposition and are not to be construed as being limiting or exhaustive.

In an E-UTRAN embodiment, the RAN 115 includes an eNB (evolved Node B, also called E-UTRAN Node B) 120, and the CN 130 includes a home subscriber server (HSS) 133, a serving gateway (SGW) 140, a mobility management entity (MME) 135, a policy and charging rules function (PCRF) 137, and a packet data network gateway (PDN-GW) 145. E-UTRAN is also called long term evolution (LTE).

In a UTRAN embodiment, the RAN 115 includes a base transfer station (BTS) (Node B) 123, and a radio network controller 125, and the CN 130 includes a serving GPRS support node (SGSN) 150, a home location register (HLR) 147), and a gateway GPRS support node (GGSN) 153.

In a GERAN embodiment, the RAN 115 includes a BTS 160 and a base station controller (BSC) 165, and the CN 130 includes a mobile switching center (MSC) 180 and a gateway MSC (GMSC) 185. This example shows the HLR 147 as being part of both UTRAN and GERAN, but this is merely exemplary.

The GMSC 185 is connected to the PSTN 190. There is a circuit-switched core network (CS CN) 137, which includes the MSC 180 and the GMSC 185. Note that the RNC 125 of UTRAN and the BSC 165 of GERAN can both access the CS CN 137.

The PDN-GW 145 and the GGSN 153 connect to the Internet (or other packet data network) 170. There is a packet-switched core network (PS CN) 131, which includes the GGSN 153 and SGSN 150. Both the RNC 125 of UTRAN and the BSC 165 of GERAN can access the PS CN 131.

The example of FIG. 1 shows a UE 110-1 that is able to connect to both the E-UTRAN 101 and the UTRAN 102 via wireless links 105-1 and 105-2, respectively. UE 110-2 can connect to the UTRAN 102 and to the GERAN 103 via wireless links 105-3 and 105-4, respectively. Exemplary embodiments herein may apply to both handovers from E-UTRAN 101 to UTRAN 102 and also from GERAN 103 to UTRAN 102.

Turning to FIG. 2, this figure shows a block diagram a portion of the wireless system 100. In FIG. 2, a UE 110 is in wireless communication via a wireless link 105 with a network node 290 of wireless network 100. The user equipment 110 includes one or more processors 220, one or more memories 225, and one or more transceivers 250 interconnected through one or more buses 227. The one or more transceivers 250 are connected to one or more antennas 228. The one or more memories 225 include computer program code 223. The one or more memories 225 and the computer program code 223 are configured to, with the one or more processors 220, cause the user equipment 210 to perform one or more of the operations as described herein.

The network node 290 may be one of the RAN network nodes in the RAN 115 for the various systems E-UTRAN 101, UTRAN 102, GERAN 103, and may implement one or more RATs corresponding to an appropriate system 101, 102, or 103. A RAT is a means for a UE to access a wireless network and includes appropriate air interfaces (e.g. spectrums, coding, channels, spreading, physical resources in time, frequency, or codes) for LTE, UMTS, GSM, CDMA, and the like. The network node 290 includes one or more processors 270, one or more memories 255, one or more network interfaces (N/W I/F(s)) 261, and one or more transceivers 260 interconnected through one or more buses 257. The one or more transceivers 260 are connected to one or more antennas 258. The one or more memories 255 include computer program code 253. The one or more memories 255 and the computer program code 253 are configured to with the one or more processors 250, cause the network node 290 to perform one or more of the operations as described herein. The one or more network interfaces 261 communicate over a network such as the networks 272 and 231. Two or more base stations communicate using, e.g. network 270. The network 272 may be wired or wireless or both. The network 231 may be wired or wireless or both may be used to communicate with other network elements.

The computer readable memories 225 and 255 may be of any type suitable to the local technical environment and may be implemented using any suitable data storage technology, such as semiconductor based memory devices, flash memory, magnetic memory devices and systems, optical memory devices and systems, fixed memory and removable memory. The processors 220 and 270 may be of any type suitable to the local technical environment, and may include one or more of general purpose computers, special purpose computers, microprocessors, digital signal processors (DSPs) and processors based on a multi-core processor architecture, as non-limiting examples.

in general, the various embodiments of the user equipment 110 can include, but are not limited to cellular telephones such as smart phones, personal digital assistants (PDAs) having wireless communication capabilities, tablets, portable computers having wireless communication capabilities, image capture devices such as digital cameras having wireless communication capabilities, gaming devices having wireless communication capabilities, music storage and playback appliances having wireless communication capabilities. Internet appliances permitting wireless Internet access and browsing, tablets with wireless communication capabilities, as well as portable units or terminals that incorporate combinations of such functions.

Embodiments of the present invention may be implemented in software (executed by one or more processors), hardware (e.g. an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium (e.g., memories 225 or 255 or other device) that may be any media or means that can contain or store the instructions for use by or in connection with an instruction execution system, apparatus, or device, such as a computer.

As stated above, although there are benefits to these types of inter-RAT handovers, there are also elements that could be improved. As an introductory example, assume the UE 110-1 is handed over from the E-UTRAN 101 to the UTRAN 102. After being handed over from E-UTRAN 101 to UTRAN 102, the UTRAN 102 performs ciphering and integrity protection for the Signaling Radio Bearers (SRBs) towards the latest configured CN domain, which is CS CN 137 in this case. After successful inter RAT handover to UTRAN, the UE may initiate a routing area update (RAU) procedure towards the PS CN 131. Since SRBs can have ciphering and integrity protection towards one CN domain only and the ciphering and integrity protection is performed towards the CS CN 137 in this case, the PS domain (e.g., PS CN 131) is left without any integrity protection in this case. The UE 110-1 then starts to ignore any Routing Area Update Accept messages from the PS CN because the UE 110-1 is not allowed to handle this message unless the PS domain has integrity protection started.

Consider the following more specific example. In case of SRVCC involving both CS and PS services, the routing area update procedure does not work in UTRAN 102 after the E-UTRAN 101 to UTRAN 102 handover of UE 110-1. The RNC 125 performs integrity protection towards the latest configured CN domain according to 3GPP specifications, which is CS CN 137. SGSN 150 does not initiate a new security mode control procedure since the SGSN 150 cannot know in this case that PS domain integrity protection has not been performed by the RNC 150. The UE 110-1 is not allowed to complete the routing area update procedure until the integrity protection is performed towards all CN domains. This leads to a situation where the PS service gets stuck in the UTRAN 102 and causes a bad end user experience because of the unsuccessful routing area update procedure. As a whole, multi-RAB inter RAT handover to UTRAN does not work well. Below is an exemplary scenario:

1. CS CN 137 and PS CN 131 send Relocation Requests for the handover to UTRAN 102 due to SRVCC triggered from E-UTRAN 101.

2. During the handover procedure, the latest CN domain for which ciphering and integrity protection is configured for Signaling RAB is CS CN. This is specified in 3GPP TS 25.331.

3. SRBs can have only one latest CN domain to which ciphering is configured. So this CN domain can be CS or PS and now the domain is CS. This means there is no integrity protection started for the PS CN 131. The integrity protection is not needed since SRB data is integrity protected.

4. The UE 110-1 triggers the Routing Area Update and PS CN 101 sends Routing Area Update Accept.

5. The UE 110-1 does not accept NAS messages from SGSN (i.e., Routing Area Update Accept) due to missing integrity protection towards the PS domain.

That is, there is no integrity protection started for PS domain though SRB data is already integrity protected but towards CS CN. UE notices this due to a supervision mechanism to monitor a start of integrity protection towards each CN domain separately and hence the UE does not accept the Routing Area Accept message from PS CN as per the conditions in 3GPP TS 24.008.

A similar problem exists for UEs with both CS and PS services in GERAN 103 and a DTM handover to UTRAN 102 of the UE 110-2 is performed. The DTM handover is a special handover type in GERAN in which the source base station system requests the target base station system to allocate both circuit-switched (CS) and packet-switched resources. This is useful in scenarios when the UE has, for instance, a conventional (CS) voice call ongoing and a packet session active (e.g., for email sync up or file download) and a handover is required from the GERAN cell that supports DTM operation to a UTRAN cell. The DTM handover is essentially composed of two handover procedures (one in the CS domain and another in the PS domain), which are synchronized and conducted in parallel.

The proposed exemplary embodiments are intended to solve the problem of a failing Routing Area Update procedure in UTRAN 102 after SRVCC from E-UTRAN 101 to UTRAN 102 involving CS voice and PS services and DTM HO from GERAN to UTRAN involving CS voice and PS services.

The following are brief introductions to two exemplary, non-limiting possible examples:

1. Upon reception of first Security Modxe Command from UTRAN after SRVCC HO, the UE 110 activates integrity protection for the latest configured CN domain (CS domain in this case) using an integrity key of a key set used towards that CN domain. If the different occurrences of the IE “CN domain indicator” in the IE “RAB information” in the Handover To UTRAN Command included both CS and PS domains, the UE AS layer shall indicate to the upper layer(s) (e.g., MM and GMM) of CS and PS domains that integrity protection for the PS domain is activated.

2. Upon completion of SRVCC HO, the UE adds an indicator in the Routing Area Update Request sent to PS CN 150 to trigger a Security Mode Control procedure for the PS domain.

The following presents more detailed descriptions of these two examples.

Regarding example I, according to current specifications, specifically 3GPP TS 25.331, section 8.3.6.3, the following are performed:

a) Set the variable LATEST_CONFIGURED_CN_DOMAIN to the value indicated in the IE “CN domain identity” of the IE “RAB information” of the IE “RAB information to setup” if all instances of the IE indicate the same CN domain, or to the CS domain when this IE is either not present or different instances indicate different CN domains; and

b) For the CN domain in variable LATEST_CONFIGURED_CN_DOMAIN set the IE “Status” in the variable CIPHERING_STATUS to “Started”; and

Based on (a) and (b) immediately above, the UE initializes the latest CN domain as CS. Further, the same 3GPP section states the following:

If the source RAT 291 is E-UTRAN 101: Upon performing SRVCC (PS to CS) or PS handover, then during the first security mode control procedure following the Inter-RAT handover to UTRAN procedure, the (UE activates integrity protection using the integrity key of the key set used (see 3GPP TS 25.331, section 8.1.12.2.2.).

The integrity protection for CS is activated at this point according to current standards. Thus, current 3GPP TS 25.331 does not say anything about the remaining PS signaling connection and the associated RABs.

Regarding 3GPP TS 24.008, section 4.1.1.1.1 states, “the CS and PS domains in the network and the MM and GMM layers in the UE, are not aware of whether integrity protection has been started in the lower layers by the other domain. It is mandatory for the network to initiate one security mode control procedure for the CS domain and one for the PS domain.” However, integrity protection is only for SRBs and hence integrity protection is common to both CS and PS by using the keys associated with the latest configured CN domain. Nonetheless, this scenario still does not allow the UE 110 to handle this message unless the PS domain has integrity protection started.

To restate the problem, integrity protection for PS is not activated in the UE and so the GMM layer is not notified that integrity protection occurs for SRBs. Integrity protection is for Signaling RBs towards one CN domain and so integrity protection was activated only for CS. To state the problem yet one more way, in the RRC layer, integrity protection is activated for SRB, e.g., using CS keys and START value. However, in the NAS layer in the UE, the PS side considers integrity protection as not being activated.

To overcome this problem, it is proposed that after inter-RAT Handover and upon reception of Security Mode Command to activate Integrity Protection, if the variable “ESTABLISHED_RABS” contains indications of both CS and PS domains, the UE shall indicate to GMM that integrity protection is activated along with indication to MM about activation of integrity protection, without changing the value of variable “LATEST_CONFIGURED_CN_DOMAIN”.

To implement this example, 3GPP TS 25.331, section 8.3.6.3 can state the following (as one possibility):

‘If all instances of the IE “CN domain identity” in the IE “RAB information” in “RAB Information to Setup” do not indicate same CN domain, then the UE shall indicate to upper layers of CS and PS domain that integrity protection is activated upon reception of first Security Mode Command to activate integrity protection following the inter RAT handover.’

Furthermore, to implement this example, 3GPP TS 24.008, section 4.1.1.1.1 can state the following:

‘One indication to the MM layer when a security mode control procedure for the CS domain is processed successfully, one indication to the GMM layer when a security mode control procedure for the PS domain is processed successfully and one indication to the MM and GMM layer when a security mode control procedure that activates integrity protection is processed successfully and this security mode command is the first one after a successful SRVCC handover from E-UTRAN to UTRAN or a successful DTM HO from GERAN to UTRAN.’

An updated scenario with example 1 is as follows, illustrated by FIG. 3. FIG. 3 is a logic flow diagram for integrity protection towards PS CN after handovers involving voice and PS services for a first example. FIG. 3 also illustrates the operation of an exemplary method, a result of execution of computer program instructions embodied on a computer readable memory, and/or functions performed by logic implemented in hardware, in accordance with an exemplary embodiment.

1. CS CN 137 and PS CN 131, e.g., the MSC 180 and the SGSN 150, respectively, send Relocation Request for the handover to UTRAN due to SRVCC triggered from E-UTRAN. See block 300 of FIG. 3.

2. During the handover procedure, latest CN domain for which ciphering and integrity protection is configured for Signaling RB is CS CN. See block 310 of FIG. 3. This is specified in 3GPP TS 25.331.

3. The SRBs can have only one latest CN domain to which ciphering is configured. So the CN domain can be CS or PS and now the CN domain is CS. RAB information contains CS and PS RABs, thus integrity protection has been activated for CS and PS domains.

a. The AS layer within the UE notifies the GMM layer that integrity protection has been activated for the PS domain and the UE notifies the MM layer for activation of integrity protection, the notifying occurring after successful processing of a Security Mode Command to activate integrity protection. See block 315 of FIG. 3. See also FIGS. 4 and 5, described below. The notification may be a UE internal implementation.

4. The UE 110 triggers Routing Area Update message (see block 320) and PS CN 131 sends Routing Area Update Accept message (block 330).

5. The UE 110 accepts NAS messages (i.e., Routing Area Update Accept) from SGSN 150 (block 340) and sends Routing Area Update Complete message (see block 350).

One possibility of performing block 315 is to perform block 360, where (in block 360), if all instances of the IE “CN domain identity” in the IE “RAB information” in the IE “RAB Information to Setup” in the “Handover to UTRAN Command” message do not indicate the same CN domain, the UE 110 indicates to upper layers of CS and PS domains (e.g., CS CN 137 and PS CN 131) that integrity protection is activated upon reception of first security mode command to activate integrity protection following the inter-RAT handover. This is described above in reference to 3GPP TS 25.331, section 8.3.6.3.

Another example of block 315 is block 370, where after a successful SRVCC handover from EUTRAN to UTRAN or a successful DTM HO from GERAN to UTRAN, the UE provides an indication to the MM and GMM layers when the UE receives the first Security Mode Command from UTRAN to activate integrity protection and that is processed successfully. This is described above in reference to 3GPP TS 24.008, section 4.1.1.1.1. A Security Mode Control is a procedure which is initiated by the Core Network by sending an RANAP Security Mode Command to the RNC and the RNC then sends RRC Security Mode Command to the UE.

Referring to FIG. 4, this figure is an illustration of a protocol stack for a PS domain, such as for use with the PS CN 131. The UE 110 includes a GMM layer 410-1, an RRC layer 410-2, a PDCP layer 410-3, an RLC layer 410-4, a MAC layer 410-5, and an L1 layer 410-6. The RRC layer 410-2 corresponds to the AS layer that may perform a portion of block 315. The GMM layer 410-1 of the UE 110 communicates with the GMM layer 430-1 of the SGSN 150 and therefore the GMM layer 410-1 is considered to be a layer of the PS domain. The layers 410-2 through 410-6 communicate with corresponding layers 420-2 through 420-6 on the RNC 125. There are additional layers of RANAP (radio access network application part), SCTP (stream control transmission protocol), IP, L2 (the data link layer), and diameter in the RNC 125 and SGSN 150, but these are not relevant to the instant embodiments. The UU and Iu-PS are interfaces.

Turning to FIG. 5, an illustration is shown of a protocol stack for a CS domain, such as for use with the CS CN 137. The UE 110 has a CM layer 510-1, an MM layer 510-2, an RR layer 510-3. LAPDm (link access protocol for the D channel for mobile) layer 510-4, and a GSM RF layer 510-5. The CM 510-1 and MM 510-2 layers communicate with corresponding layers CM 530-1 and MM 530-2 in the MSC 180. The MM layer 510-2 is considered to be a layer of the CS domain. The RR 510-3, LAPDM 510-4, and GSM RF 510-5 layers communicate with corresponding layers RR 520-3, LAPDM 520-4, and GSM RF 520-5 in the BSC 160. The RR layer 510-3 corresponds to the AS layer that may perform a portion of block 315. The layers BTSM (BTS management), DTAP (direct transfer application part), SCCP (signaling connection control port), and MTP (message transfer part) layers are not relevant to the exemplary embodiments. The Urn, Abix, and A interfaces are also shown.

Regarding example 2, this entails introducing a new indication (e.g., a new IE) in the Routing Area Update request towards the SGSN 150 to trigger the SGSN 150 to initiate a security mode control procedure. The SMC procedure may contain the same keys CK_PS, IK_PS and algorithms that were sent to RNC right after the HO. The CK_PS and IK_PS are ciphering and integrity, respectively, packet-switched security keys. CN may perform authentication and key agreement procedure to change the keys. In this case, the CN shall indicate the RNC also that new keys will be used by setting “key status” IE in the RANAP Security Mode Command message.

An exemplary updated scenario with example 2 is as follows and is illustrated by FIG. 6. FIG. 6 is a logic flow diagram for integrity protection towards PS CN after handovers involving voice and PS services for a second example. FIG. 6 also illustrates the operation of an exemplary method, a result of execution of computer program instructions embodied on a computer readable memory, and/or functions performed by logic implemented in hardware, in accordance with an exemplary embodiment. Some of the operations in the blocks are the same as blocks in FIG. 3.

1. The CS CN 137 and PS CN 131 send Relocation Requests for the handover to UTRAN due to SRVCC triggered from E-UTRAN. See block 300 of FIG. 6.

2. During the handover procedure, latest CN domain for which ciphering and integrity protection is configured for Signaling RB is CS CN. See block 310 of FIG. 6. This is specified in 3GPP TS 25.331.

3. The SRBs can have only one latest CN domain to which ciphering is configured. So the CN domain can be CS or PS and now the domain is CS.

4. The UE triggers a Routing Area Update message with SRVCC HO indication. See block 620. Note that the Routing Area Update message could also alternatively includes a DTM HO indication for GERAN to UTRAN handovers. This indication could be a new IE in the Routing Area Update Request message with a bit set indicating CN to explicitly trigger Security Mode Control procedure.

5. Responsive to the SRVCC HO indication received in the RAU request, the SGSN performs a Security Mode Control Procedure (see block 630) that may contain the same keys CK_PS, IK_PS and algorithms that were sent to the RNC 125 during the relocation procedure or CN may assign new keys and include them in the RANAP Security Mode Command. As an introduction to the Security Mode Control Procedure, this authentication procedure may be triggered upon RAU where the CN may ask for a UE identity and agreement is made as to the keys to be used by the UE during the new connection being established. The CN informs the RNC about the agreed keys for integrity protection and encryption along with the preferred algorithms for integrity protection and encryption. The RNC selects the algorithm to be used and sends a Security Mode Command to the UE indicating the CN domain to which this procedure belongs and the UE/RNC agree about the activation of encryption and integrity protection in UL and DL for each Signaling RB (also associated data RB, if these exist already). The RNC sends a RANAP SECURITY MODE COMPLETE to CN after receiving successful response from the UE and then the CN sends RAU-Accept/LU-Accept, and the like, depending on the procedure or may continue the RAB Setup procedure. In response to the Security Mode Control Procedure, the upper layers (e.g., the GMM layer) of the UE 110 are therefore informed of the activation of integrity protection of the PS CN.

6. Upon successful completion of SMC procedure, the SGSN 150 sends Routing Area Update Accept message to the UE. See block 635.

7. The UE accepts NAS messages from SGSN (i.e., Routing Area Update Accept) (block 340) and sends Routing Area Update Complete message (block 350) (e.g., since the upper layers, e.g., the GMM layer, of the UE 110 are informed of the activation of integrity protection of the PS CN).

The example 2 can result in additional signaling (due to SMC procedure from SGSN) compared to the example I, but the example 2 helps with layer separation within the UE. That is, the UE will notify GMM layer about the activation of integrity protection in response to the security mode control procedure being successfully completed for the PS domain and the UE does not have to relate the activation of integrity protection to GMM layer based on the status of MM layer.

It may be possible that UTRAN may need to know if the UE is capable of informing its GMM layer about activation of integrity protection through a UE capability so that the UTRAN could indicate to SGSN about pending integrity protection, if UE is not capable of doing this. For example if there are some newer UEs which can support method 1 while some legacy UEs would not have this capability, a capability indication of the UE may be needed for UTRAN to decide how to handle different UEs after an inter-RAT handover involving CS and PS domains.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2G second generation
3G third generation
3GPP third generation partnership project
AS access stratum
BSC base station controller
BTS base transceiver station
CM connection management
CN core network
CS circuit switched
DL downlink (from base station to user equipment)
DTM dual transfer mode
EDGE enhanced data rates for GSM evolution
eNode B (eNB) evolved Node B (LTE base station)
E-UTRAN evolved UTRAN
GERAN GSM EDGE radio access network
GGSN gateway GPRS support node
GMM GPRS mobility management
GMSC gateway MSC
GPRS general packet radio service
GSM global system for mobile communications
HLR home location register
HO handover
HSS home subscriber server
HTTP hypertext transfer protocol
IE information element
IMS IP multimedia subsystem
IP Internet protocol
L1 physical layer, also termed PHY
LTE long term evolution
Node B (NB) Node B (base station in UTRAN)
MAC medium access control
MM mobility management
MME mobility management entity
MSC mobile switching center
NAS non access stratum
PCRF policy control and charging rules function
PDCP packet data convergence protocol
PDN-GW packet data network-gateway
PSTN public switched telephone network
PS packet switched
RB radio bearer
RAB radio access bearer
RAN radio access network
RAT radio access technology
RAU routing area update
RLC radio link control
RNC radio network controller
RR radio resource
RRC radio resource control
SGSN serving GPRS support node
SMC security mode command
SRB signaling radio bearer
SRVCC single radio voice call continuity
TS technical standard
UE user equipment
UL uplink (from UE to base station)
UMTS universal mobile telecommunications system
UTRAN universal terrestrial radio access network
VoIP voice over IP

What is claimed is:

1. A method, comprising:
receiving at a user equipment information indicating different core network domains will be used for a first data service and a second data service after handover from a first radio access technology to a second radio access technology, wherein the first data service will be handled by a first one of the different core network domains after handover and the second data service will be handled by a second one of the different core network domains after handover, wherein integrity protection is activated for both the first and second core network domains but an element in the user equipment does not have an indication integrity protection is activated for the second core network domain; and
providing by the user equipment a notification for the element in the user equipment that integrity protection has been activated for the second core network domain.

2. The method of claim 1, wherein the first data service comprises a voice data service and wherein the second data service comprises a packet switched data service.

3. The method of claim 2, wherein the handover is a single radio voice call continuity handover from a radio access technology for evolved universal terrestrial radio access network to a radio access technology for universal terrestrial radio access network.

4. The method of claim 3, wherein the voice data service is an Internet protocol multimedia subsystem data service in the evolved universal terrestrial radio access network and will be a circuit-switched data service in the universal terrestrial radio access network after handover.

5. The method of claim 3, wherein the voice data service is a voice over Internet protocol data service in the evolved universal terrestrial radio access network and will be a circuit-switched data service in the universal terrestrial radio access network after handover.

6. The method of claim 1, wherein the handover is a dual transfer mode handover from a radio access technology for global system for mobile communications (GSM) enhanced data rates for GSM evolution radio access network to a radio access technology for universal terrestrial radio access network.

7. The method of claim 6, wherein the first data service comprises a voice data service that is a circuit-switched data service in the global system for mobile communications (GSM) enhanced data rates for GSM evolution radio access network and that will be a circuit-switched data service in the universal terrestrial radio access network after handover.

8. The method of claim 1, wherein the information comprises that all instances of “CN domain identity in the information element “radio access bearer information” information elements in a “radio access bearer information to setup” received in a handover to UTRAN command message do not indicate a same core network domain.

9. The method of claim 8, wherein providing the notification is performed in response to reception of a first security mode command to activate integrity protection following the handover.

10. The method of claim 1, wherein providing the notification is performed in response to a security mode control procedure that activates integrity protection being processed at least in part by user equipment successfully and this security mode command is a first one after the handover.

11. The method of claim 1, wherein the method further comprises, after the providing, accepting at the user equipment non access stratum messages from a network node in the packet switched core network domain.

12. The method of claim 1, wherein providing further comprises an access stratum layer of the user equipment providing the notification to general packet radio service mobility management and mobility management layers within the user equipment.

13. An apparatus, comprising:
one or more processors; and
one or more memories including computer program code,
the one or more memories and the computer program code configured to, with the one or more processors, cause the apparatus to perform at least the following:
receiving at a user equipment information indicating different core network domains will be used for a first data service and a second data service after handover from a first radio access technology to a second radio access technology, wherein the first data service will be handled by a first one of the different core network domains after handover and the second data service will be handled by a second one of the different core network domains after handover, wherein integrity protection is activated for both the first and second core network domains but an element in the user equipment does not have an indication integrity protection is activated for the second core network domain; and
providing by the user equipment a notification for the element in the user equipment that integrity protection has been activated for the second core network domain.

14. A computer program product comprising a computer-readable storage medium bearing computer program code embodied therein for use with a computer, the computer program code comprising code for performing the method of claim 1.

15. A method, comprising:
receiving at a network node a message indicating a user equipment has performed a handover involving a first data service and a second data service from a first radio access technology to a second radio access technology, wherein the first data service will be handled by a first one of the different core network domains after handover and the second data service will be handled by a second one of the different core network domains after handover; and
performing, in response to the message, by the network node a security mode control procedure to activate integrity protection towards the second core network domain.

16. The method of claim 15, wherein the security mode control procedure contains at least ciphering and integrity keys.

17. The method of claim 16, wherein the security mode control procedure further contains one or more algorithms.

18. The method of claim 15, wherein the message comprises a routing area update request message.

19. The method of claim 17, wherein the method further comprises, responsive to a successful completion of the security mode control procedure, sending by the network node a routing area update accept message toward the user equipment.

20. The method of claim 17, wherein the routing area update request message comprises an information element with a bit set indicating the second core network domain should explicitly trigger the security mode control procedure.

21. The method of claim 15, wherein the first data service comprises a voice data service and wherein the second data service comprises a packet switched data service.

22. The method of claim 21, wherein the message comprises a routing area update message comprising an indication of a single radio voice call continuity handover indicating a handover from a radio access technology for evolved universal terrestrial radio access network to a radio access technology for universal terrestrial radio access network.

23. The method of claim 21, wherein the message comprises a routing area update message comprising an indication of a dual transfer mode handover indicating a handover from a radio access technology for global system for mobile communications (GSM) enhanced data rates for GSM evolution radio access network to a radio access technology for universal terrestrial radio access network.

24. The method of claim 15, wherein:
integrity protection is activated for both the first and second core network domains but an element in the user equipment does not have an indication integrity protection is activated for the second core network domain; and
performing the security mode control procedure causes the entity in the user equipment to be informed that integrity protection has been activated for the second core network domain.

25. A computer program product comprising a computer-readable storage medium bearing computer program code embodied therein for use with a computer, the computer program code comprising code for performing the method of claim 15.

26. An apparatus, comprising:
one or more processors; and
one or more memories including computer program code,
the one or more memories and the computer program code configured to, with the one or more processors, cause the apparatus to perform at least the following:
receiving at a network node a message indicating a user equipment has performed a handover involving a first data service and a second data service from a first radio access technology to a second radio access technology, wherein the first data service will be handled by a first one of the different core network domains after handover and the second data service will be handled by a second one of the different core network domains after handover; and
performing, in response to the message, by the network node a security mode control procedure to activate integrity protection towards the second core network domain.
